(19) United States
(12) Patent Application Publication
(10) Pub. No.: US 2006/0096191 A1
(43) Pub. Date: May 11, 2006

(54) Maintenance free jamb

(75) Inventor: George Liu, Duluth, GA (US)

Correspondence Address: STANDLEY LAW GROUP LLP, 495 METRO PLACE SOUTH, SUITE 210, DUBLIN, OH, 43017, US

(73) Assignee: Evermark LLC, Buford, GA (US)

(21) Appl. No.: 10/981,933

(22) Filed: Nov. 5, 2004

(51) Int. Cl. E06B 1/04

(52) U.S. Cl. 52/204.1

(57) ABSTRACT

A jamb comprising: (a) a main portion comprising a body portion and a doorstop portion; and (b) a cover member adhered to the main portion. The body portion has a width defined by a first edge and a second edge. The doorstop portion has a width defined by a third edge and a fourth edge. The width of the doorstop portion is less than the width of the body portion. The body portion and the doorstop portion each have a generally rectangular cross section. The doorstop portion is disposed on the body portion such that the first edge of the body portion and the third edge of the doorstop portion are aligned so as to form an inside corner and impart to the main portion a generally L-shaped cross section. The cover member extends from about the inside corner around the doorstop portion to at least the body portion.

### TECHNICAL FIELD OF THE INVENTION

The present invention relates generally to door frames used in a building, and more particularly to a door jamb that increases both the aesthetic and structural integrity of a door frame and reduces maintenance requirements.

### BACKGROUND OF THE INVENTION

A conventional exterior door frame typically includes a door jamb system. The door jamb system provides a weather-tight seal between the interior and exterior of a building when a door attached thereto is shut within the frame. The jamb system includes side jambs that are located along the inner peripheral vertical edges of the frame and abut the side edges of the door when the door is shut within the frame. A head jamb is located along the top inner periphery of the door frame and abuts the top edge of the door when the door is shut into the frame. The side and head jambs also typically include some form of weather strip to prevent air and other outdoor elements from entering the building interior when the door abuts the side and head jambs. In addition to providing the weather-tight seal, the side and head jambs prevent the door from swinging through the frame.

Because an exterior door frame acts as an interface between the building interior and exterior, the associated jamb system is continually exposed to harsh conditions, such as moisture, sunlight and temperature extremes, which typically cause damage to and decrease the useful life of the jamb system. Therefore, conventional system components must be protected from such conditions to ensure structural longevity.

Several approaches have been used in the past to protect jamb system components. In a traditional approach, wood-based door jambs are covered with paint, varnish or other wet applied protective coatings. However, such wood-based preservative systems require periodic reapplication and typically only provide marginal protection to the jamb.

In another approach, film or laminate envelopes are applied over wood-based door jambs and bonded thereto with adhesives. However, such coverings leave unattractive edges when the jamb is machined for the addition of hinges and strike holes. Further the adhesives often become detached from the jambs due to moisture seepage and thermal bow caused by extreme temperature differences between the interior and exterior of the building.

In yet another approach, to overcome the above-mentioned problems associated with wood-based doorjamb systems, doorjamb systems manufactured from solid cellular plastic material, hollow rigid plastic materials or composite materials have been produced. Doorjamb systems made from such materials do not require the periodic reapplication of wet applied protective coverings, nor do such plastic-based systems require any type of protective covering. However, door jambs made from such synthetic materials often lack the structural integrity of wood-based door jambs—they often wobble or bow after a short period. In addition, such systems are typically vulnerable to thermal bow and thermal expansion and contraction. As a result, doors mounted within frames having such jamb systems typically do not fit in a weather-tight manner once the jamb system has been subjected to such conditions.

In another approach, door jamb clads manufactured from steel, aluminum or plastic have been used in the past to cover portions of wood-based door frames to protect the door frames from exposure to extreme weather conditions. However, a typical door jamb clad covers only a part of the door frame, thereby requiring a high quality substrate, such as wood, to be used as the frame itself to maintain both the structural and aesthetic integrity of the frame. Further, such doorjamb clads typically require a time consuming installation procedure, thereby increasing the associated cost of the door frame system.

Therefore, it would be desirable to provide a door frame having a clad/jamb system that is integrally attached to the door frame to enhance both the structural and aesthetic qualities of the door frame and to permit the frame to be constructed of a material less expensive than high quality wood while maintaining frame structural integrity. It would also be desirable to provide a door frame having a clad/jamb system that makes the frame less susceptible to changes caused by exposure to extreme weather conditions and thereby increases the overall life of the frame.

In view of the present disclosure or through practice of the present invention, other advantages may become apparent.

### SUMMARY OF THE INVENTION

In general terms, the present invention includes a jamb for use in a door frame having a door hingedly attached thereto, comprising: (a) a main portion comprising a body portion and a doorstop portion; and (b) a cover member adhered to the main portion. The body portion has a width defined by a first edge and a second edge. The doorstop portion has a width defined by a third edge and a fourth edge. The width of the doorstop portion is less than the width of the body portion. The body portion and the doorstop portion each have a generally rectangular cross section. The doorstop portion is disposed on the body portion such that the first edge of the body portion and the third edge of the doorstop portion are aligned with one another so as to form an inside corner and impart to the main portion a generally L-shaped cross section. The cover member extends from about the inside corner around the doorstop portion to at least the body portion.

In one embodiment of the jamb for use in a door frame according to the present invention, the doorstop portion has disposed therein a channel.

In one embodiment of the jamb for use in a door frame according to the present invention, the cover member is constructed from a thermoplastic material.

In one embodiment of the jamb for use in a door frame according to the present invention, the cover member is insect, decay, and moisture resistant.

The present invention also provides for a jamb for use in a door frame having a door hingedly attached thereto comprising: (a) a main portion comprising a body portion having disposed thereon a doorstop portion; and (b) a cover portion adhered to the main portion. The doorstop portion has a width less than the body portion such that the main portion has a generally L-shaped cross section. An inside corner of the main portion is formed by the intersection of the doorstop portion and the body portion. The cover portion extends from about the inside corner over the doorstop portion to the body portion.

In one embodiment of the jamb for a door frame according to the present invention, the doorstop portion has disposed therein a channel.

In one embodiment of the jamb for a door frame according to the present invention, the cover member is constructed from a thermoplastic material.

In one embodiment of the jamb for a door frame according to the present invention, the cover member is insect, decay, and moisture resistant.

### BRIEF DESCRIPTION OF THE DRAWINGS

FIG. 1 depicts a door frame illustrating the use of a jamb constructed in accordance with one embodiment of the present invention.

FIG. 2 depicts a cross section of a jamb constructed in accordance with one embodiment of the present invention.

FIG. 3 is an orthogonal view of a jamb in accordance with one embodiment of the present invention.

### DETAILED DESCRIPTION OF THE PREFERRED EMBODIMENT(S)

In accordance with the foregoing summary of the invention, the following presents a detailed description of the preferred embodiment of the invention which is presently considered to be its best mode.

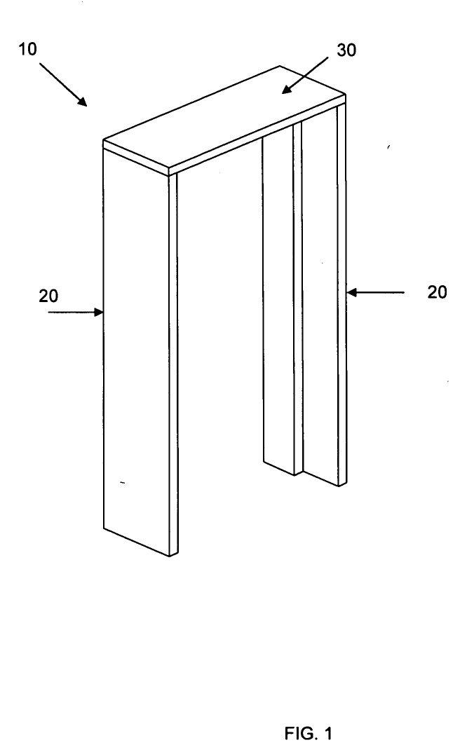

FIG. 1 presents a door frame assembly comprising a pair of vertical jambs 20 whose upper ends are connected to top jamb 30. Although the following discussion centers about the vertical jamb 20, it should be understood that the top jamb 30 may be similarly constructed.

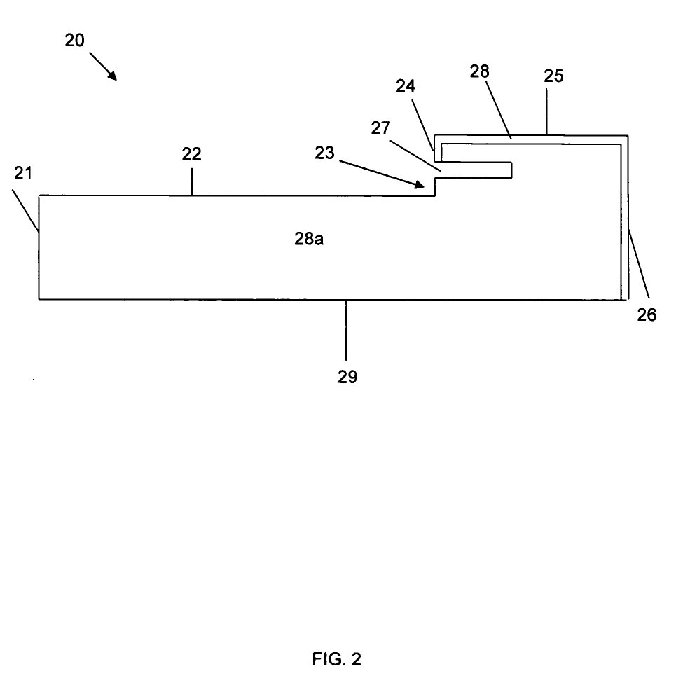

FIG. 2 illustrates the cross section of a vertical jamb 20 in accordance with one embodiment of the present invention. Vertical jamb 20 has a plurality of surfaces 21, 22, 24, 25, 26 and 29 defining its exterior. The vertical jamb 20 is comprised of two portions, a main portion 28a and a cover portion 28b. Main portion 28a is divided into two portions, a body portion (defined by the cross sectional area of surfaces 21 and 29) and a doorstop portion (defined by the cross sectional area of surfaces 24 and 25).

When used in an exterior door jamb system, vertical jamb 20 is situated such that surfaces 25 and 26 are exposed to the outside of the building, while surfaces 21 and 22 are exposed to the inside of the building. Typically, the hinges and strike plate for mounting a door are disposed on surface 22. The intersection of surfaces 22 and 24 define inside corner 23. Surface 24 acts as a doorstop upon which a door (not shown) hung in the door jamb system rests against when closed.

An optional groove 27 may be disposed in surface 24 to accommodate the insertion of weather-stripping to improve the seal between a door and the door frame.

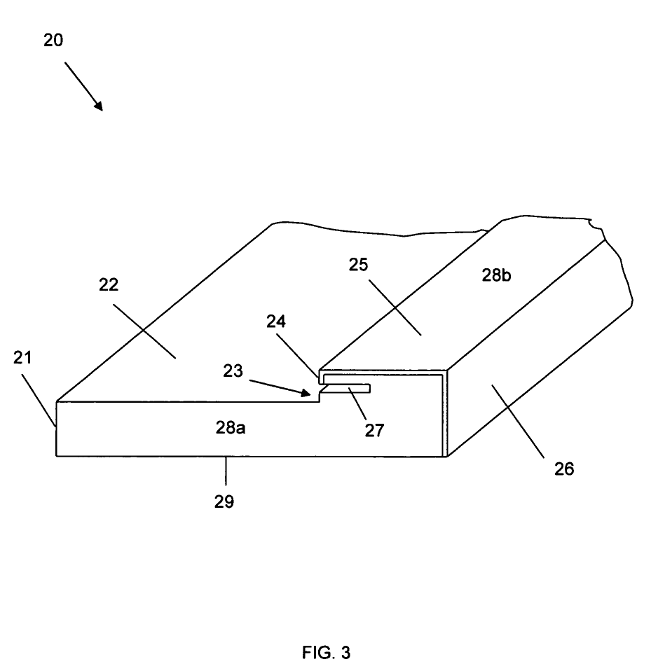

FIG. 3 presents an orthogonal view of an end section of the vertical jamb 20 for ease of visualization.

The vertical jamb of the present invention is fabricated by providing a main portion and adhering thereto a cover portion. By controlling the tolerances of the main portion and the cover portion (control of which is readily understood by one of ordinary skill in the respective arts), a good fit between the main portion and the cover portion may be effected. By having components that naturally fit well together, the adhesive used to bond the two components has a better effectiveness and the quantity of adhesive required for each vertical jamb may be minimized—thereby suppressing manufacturing costs.

In one embodiment, the main portion 28a is constructed from a single piece of wood; however, it may be constructed from a plurality of staves connected to one another in an end-to-end arrangement so as to mimic the use of a single piece of wood. The cross section of the main portion 28a is created through known fabrication techniques such as milling; however other suitable techniques may be employed. It is not intended that the cross section of the main portion 28a used in the present invention is limited to that which is disclosed herein, but rather that the main portion may have a variety of possible cross sectional configurations, so long as the main portion has disposed thereupon—either unitarily or affixed thereto—a doorstop portion so as to define that portion of the jamb which is exposed to the outdoors and that portion which is exposed to the interior of the building.

In one embodiment, the cover portion 28b is constructed from a thermoplastic material such as polypropylene, polyethylene, polyvinylchloride, or any other suitable durable, moisture, decay and insect resistant material—such as aluminum. The cross section of the cover portion 28b is controlled through known plastics fabrication techniques such as extruding; however, other suitable techniques may be employed. Although FIG. 2 shows that the cover portion 28b extends from the intersection of surfaces 26 and 29 to the intersection of surface 24 and groove 27 (nearest the intersection of surface 24 and 25), the cover portion may be extended so as to extend onto surface 29 and to inside corner 23. In those embodiments where cover portion 28b extends to inside corner 23, groove 27 may be milled after the adhesion of the cover portion to the main portion 28a.

Suitable adhesives for attaching the cover portion to the body portion include Titebond Polyurethane glue produced by Franklin International; however, any adhesive capable of maintaining adhesion throughout the temperature and humidity cycles that the cover portion of the jamb will be exposed to may be used.

By employing the teachings of the present invention it has been advantageously found that a maintenance free jamb can be produced which offers the aesthetic benefits of prior art PVC jambs while offering a substantial reduction in price as compared to the prior art jambs. Table 1, below, compares the market price of several competing jamb technologies with the present invention. All prices are based on per set (two piece) purchase.

TABLE 1

| All PVC | | | |
|---|---|---|---|
| Jamb | PVC Clad Jamb | Aluminum Clad Jamb | Inventive Jamb |
| $39.00 | $29.00 | $48.00 | $21.00 |

Thus, it is readily apparent that the inventive jamb offers substantial savings over the prior art jambs.

In view of the present disclosure or through practice of the present invention, it will be within the ability of one of ordinary skill to make modifications to the present invention, such as through the use of equivalent arrangements and compositions, in order to practice the invention without departing from the spirit of the invention as reflected in the appended claims.

What is claimed is:

1. A jamb for use in a door frame having a door hingedly attached thereto, comprising:
(a) a main portion comprising a body portion and a doorstop portion, said body portion having a width defined by a first edge and a second edge, said doorstop portion having a width defined by a third edge and a fourth edge, wherein said width of said doorstop portion is less than said width of said body portion, said body portion and said doorstop portion each having a generally rectangular cross section, said doorstop portion disposed on said body portion such that said first edge of said body portion and said third edge of said doorstop portion are aligned with one another so as to form an inside corner and impart to said main portion a generally L-shaped cross section; and
(b) a cover member extending from about said inside corner about said doorstop portion to at least said body portion.

2. The jamb for use in a door frame according to claim 1 wherein said doorstop portion has disposed therein a channel.

3. The jamb for use in a door frame according to claim 1 wherein said cover member is constructed from a thermoplastic material.

4. The jamb for use in a door frame according to claim 1 wherein said cover member is insect, decay, and moisture resistant.

5. A jamb for use in a door frame having a door hingedly attached thereto, said door jamb system comprising:
(a) a main portion comprising a body portion having disposed thereon a doorstop portion, wherein said doorstop portion has a width less than said body portion such that said at least one vertical jamb has a generally L-shaped cross section wherein an inside corner of said main portion is formed by the intersection of said doorstop portion and said body portion; and
(b) a cover portion adhered to said main portion, said cover portion extending from about said inside corner over said doorstop portion to said body portion.

6. The jamb for a door frame according to claim 5 wherein said doorstop portion has disposed therein a channel.

7. The jamb for a door frame according to claim 5 wherein said cover member is constructed from a thermoplastic material.

8. The jamb for a door frame according to claim 5 wherein said cover member is insect, decay, and moisture resistant.
